(19) United States
(12) Patent Application Publication
(10) Pub. No.: US 2010/0288863 A1
(43) Pub. Date: Nov. 18, 2010

(54) PORTABLE MANUAL HAND-HELD PAPER SHREDDER

(76) Inventors: Mingwu Bai, (US); Ming Chen, (US)

Correspondence Address: Mingwu Bai;Ming Chen, Blacksmith SQ, Ashburn, VA, 20147, US

(21) Appl. No.: 12/467,058

(22) Filed: May 15, 2009

(51) Int. Cl. B02C 23/00

(52) U.S. Cl. 241/100

(57) ABSTRACT

A manual hand-held device for shredding partial area of a paper comprising a handler, a punch holder, a punch support, and a punch under which distributes an array of die bars or multi side edged blades is disclosed. The pivoted handler actuates the punch moving vertically by hand force. Paper sheet is fed into the space between holder and the punch support. Selected area of a paper can be shredded into pieces of small dots or strips.

### BACKGROUND OF THE INVENTION

People receive bill and account information letters from gas, water, and electricity, medical, dental, shop, insurance, credit card, and bank companies every week. These records will be archived for some time, while some confidential information such as financial and personal records of name and address, phone number, account number, and passwords need be destroyed to prevent increased incidents of information theft.

Electric paper shredders have been used in government agencies and corporations, their cost and bulk made them not accessible or not necessary to a family and small business. To reduce the amount of trash from shredders significantly, only part portion of a paper need be destroyed, and then the paper can be thrown away with other garbage or go for recycle.

Also in general life, sometimes there is need to archive some written papers containing working memo, design idea, password memo, and working records etc but with the sensitive information removed.

Therefore, there exists a need for a manual, hand-held paper shredded that is handy to use and small for storage, and particularly, to shred partial area of a paper of sensitive information. It also needs to reduce the amount of shredder waste, and to recycle the paper in which sensitive information has been cut out.

One advantages of the invention is that it does not need electric power or battery because there is no motor to be energized in the device, so it is easy use in any time. Another advantage is that is has both small size and light weight for easy carrying and storage.

### SUMMARY OF THE INVENTION

A manual hand-held paper shredder device for shredding part area of paper comprises a handle portion and a punch portion. The handle portion can impart force on punch by a pivotal movement. The punch portion has an array of die bars or side edged blades. The punch support has an array of female die holes or surface grooves. The paper can be moved between punch and punch support to select the area to be punched and shredded.

### BRIEF DESCRIPTION OF THE DRAWINGS

FIG. 1 is a perspective view of a manual hand-held paper shredder;

FIG. 2 is an exploded view of the manual hand-held paper shredder;

FIG. 3 is a side view of the manual hand-held shredder before punching a paper of selected area;

FIG. 4 is a side view of the manual hand-held shredder during punching a paper of selected area;

FIG. 5 is a perspective bottom view of array of side edged blades;

FIG. 6 is a perspective top view of array of side edged blades;

FIG. 7 is a perspective view of punch support on which surface shallow grooves are distributed;

FIG. 8 is a perspective view of array of male circular punch dies at their ends;

FIG. 9 is a perspective view of punch support on which female die holes are distributed;

### DESCRIPTION OF PREFERRED EMBODIMENTS

Although the present invention can be made in many different forms, the presently preferred embodiments are described in this disclosure and shown in the attached drawings. This disclosure exemplifies the principles of the present invention and does not limit the broad aspects of the invention only to the illustrated embodiments.

The manual hand-held paper shredder is preferably made of metal parts of a material such as thin metal sheet. A feature of the invention is the fact that some parts may snap into place and be held assembled without use of separate fasteners.

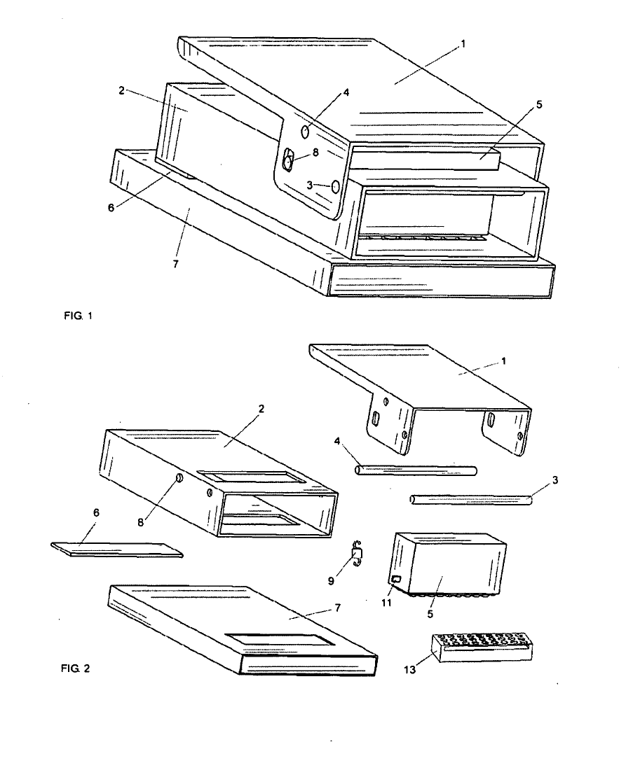

Referring first to FIG. 1, a handler 1 is installed and connected to holder 2 by a shaft 3. A shaft 4 is installed in the handler 1. A punch 5 is installed in the holder 2, the punch 5 can move vertically and positioned by the top and bottom rectangles holes in the holder 2. A rear pad 6 sits on the top rear receptacle 7 to separate holder 2 and bottom receptacle 7 with a space of thickness of several papers.

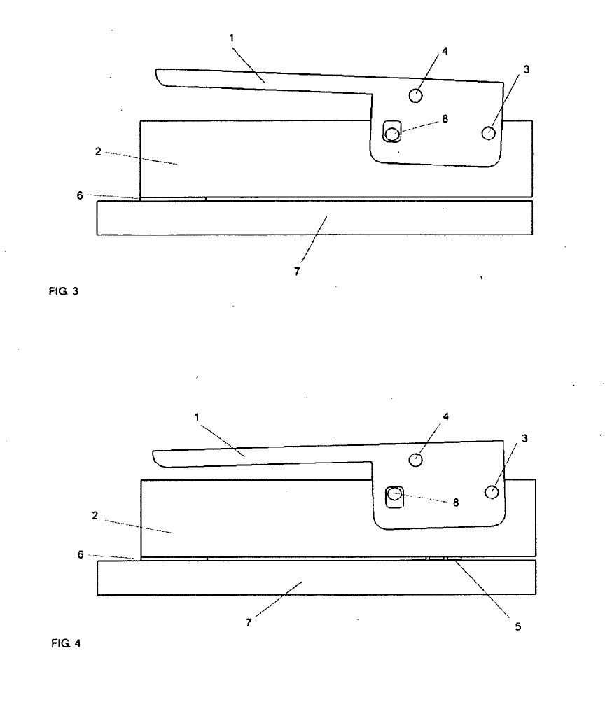

Referring next to FIG. 2, an exploded view illustrates the order in which the parts are assembled.

The spring 9 is hooked by connector 11 and a hook in the top inside of hold 2. The second spring 10 (same as spring 9, not shown) is hooked in the other side of punch 5 and top inside of holder 2. The spring 9 and spring 10 pull the punch 5 upwardly, and the pad 8 is fixed on the side of holder 2 and it restrains punch 5 from being over lifted by limit the pivoted handler 1.

The punch 5 holds array of male die bars or side edged blades, the punch support 13 sits on the inside of receptacle 7.

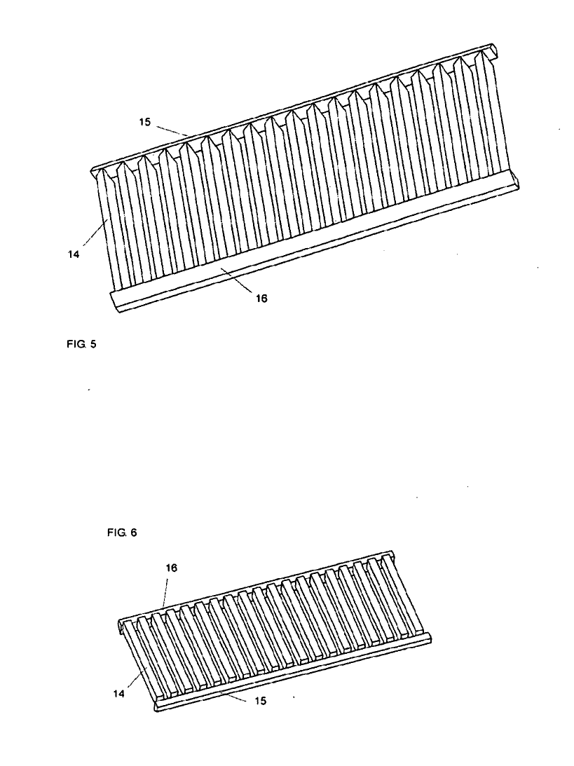

Referring next to FIG. 3 and FIG. 4, in operation of the punch, the user depresses the handler 1 causing it move from the position of FIG. 3 to FIG. 4 whereby the shaft 4 depresses punch 5 causing the array of male die bars or side edged blades depressed and shredding papers that is inserted between the holder 2 and the receptacle 7. When the handler 2 is released, the spring 9 and spring 10 (same as spring 9, not shown) return the handler 2 and shaft 4 to the position shown in FIG. 3.

The bottom receptacle 7 collects shredded dots or strips, and a side window (not shown) can be open so to throw away the wastes to bags or trash cans.

The manual hand-held paper shredder can shred paper of selected area into circular dots or strips depending on the installation of array of male punch die bars or array of side edged blades.

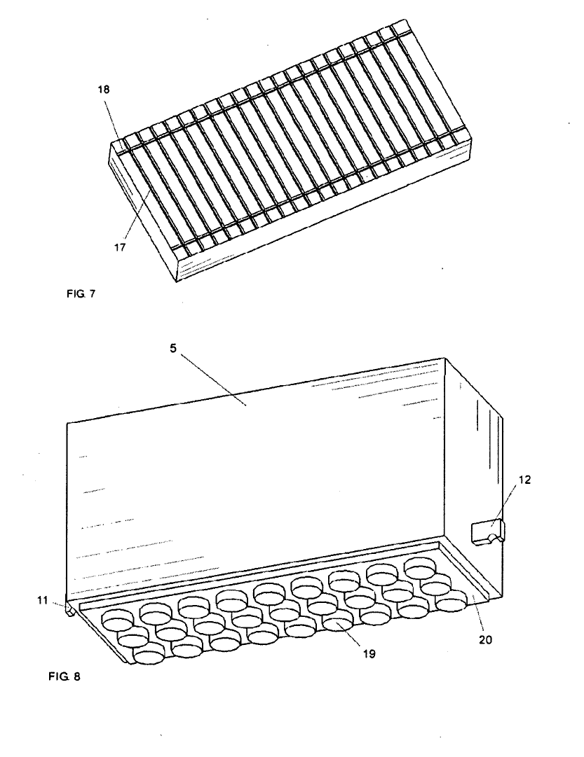

Referring next to FIG. 5, FIG. 6, and FIG. 7, if the punch 5 is made of side edged blades such as blade 14, blade 15, and blade 16, and corresponding punch support with surface grooves like groove 17 and groove 18 is installed, the device will shred the paper of selected area into strips.

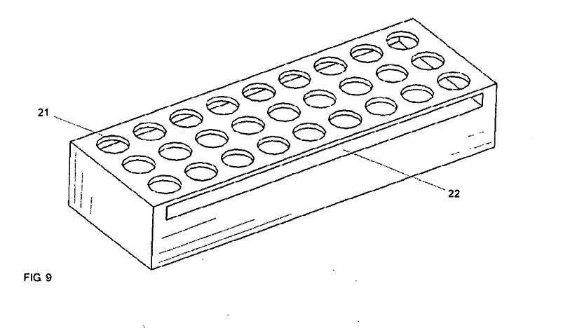

Referring next to FIG. 8 and FIG. 9, if the punch 5 is made of male punch die bars at its bottom end like male die bar 19, and corresponding female die support like female die hole 21 is installed, the device will shred the paper of selected area into circular dots. The diameter of male punch die is a little smaller than that of female die holes. The shredded dots can be moved into receptacle 7 from the empty slot 22.

According to the provisions of the patent statues, we have explained the principle, preferred construction of the invention and have illustrated and described what we now consider to represent its best embodiments. However, it should be understood that within the scope of the claims and the foregoing description, the invention may be practiced otherwise than specifically illustrated and described.

It is to be understood that the manual hand-held paper shredder body shown in FIG. 1 described above is merely illustrative of bodies which can be embodies in the shredder construction of the invention and the invention is in no way limited to exact construction and shape.

We claim:

1. A paper shredder composing a base having a receptacle, a handler, a space formed between said handler and said receptacle, a punch, a holder, punch support, said punch is guided for reciprocal toward and away from said holder, said punch being formed an array of male die bars underneath the said punch, said punch support being formed with an array of female die holes aligned with said array of male die bars, a handle having a lever at its forward end, said lever comprising means for pivotal movement of said handle relative to said base when said lever is depressed, means on a lower surface of said handle positioned above said punch to transmit pivotal movement of said lever to force simultaneous downward movement of said punch and said male die bars when said lever is depresses against force of said spring means.

2. A punch according to claim 1 in which said array of male die bars can be array of side edged blades, and correspondingly, a punch support according to claim 1 in which said array of female die holes can be punch support with array of surface grooves.

3. The number of male die bars in claim 1 and said side edged blades in claim 2 may decrease or increase; the distribution, geometry and alignment of array of said male circular die bars in claim 1 and said side edged blades in claim 2 may change; said spring in claim 1 may sit on the inside of said holder to push the said punch upward.
